(19) United States
(12) Patent Application Publication
(10) Pub. No.: US 2008/0278420 A1
(43) Pub. Date: Nov. 13, 2008

(54) SOURCE DRIVER AND GAMMA CORRECTION METHOD THEREOF

(75) Inventor: Shing-Wei Chang, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: DENMOS TECHNOLOGY INC., Hsinchu (TW)

(21) Appl. No.: 11/828,342

(22) Filed: Jul. 25, 2007

(30) Foreign Application Priority Data
May 9, 2007 (TW) 96116456

(51) Int. Cl. G09G 3/30; G06K 9/40; G09G 3/36; G09G 5/02

(52) U.S. Cl. 345/77; 345/100; 345/601; 345/87; 382/274

(57) ABSTRACT

A source driver and a Gamma correction method thereof with lower layout area and preferred Gamma correction performance are provided. The source driver includes a Gamma correction unit, a latch unit, and a digital-to-analog converter (DAC). The Gamma correction unit receives an original image data, and converts the original image data to a corresponding corrected image data. The latch unit is coupled to the Gamma correction unit. The DAC is coupled to the latch unit, so as to convert the corrected image data to a corresponding analog drive signal. In the Gamma correction method, first, a correction unit to correct an original image data to a corresponding corrected image data is provided, and the corrected image data is converted into a corresponding analog drive signal.

### CROSS-REFERENCE TO RELATED APPLICATION

This application claims the priority benefit of Taiwan application serial no. 96116456, filed May 9, 2007. All disclosure of the Taiwan application is incorporated herein by reference.

### BACKGROUND OF THE INVENTION

1. Field of the Invention

The present invention relates to a source driver. More particularly, the present invention relates to a source driver and a Gamma correction method thereof with lower layout area and preferred Gamma correction performance for driving a display panel.

2. Description of Related Art

Currently, display panel has been widely utilized in various products, such as TV sets, and computer screens. The display panel requires a source driver to drive the display panel and control the brightness of the image through the Gamma correction performance of the source driver, so as to achieve a preferred image quality.

FIG. 1 is a circuit diagram of a conventional source driver. The conventional source driver includes a plurality of source drive units 10, a shift register 11, and a Gamma reference voltage generation unit 12. Each source drive unit 10 is coupled to each corresponding output end of the shift register 11. A Gamma reference voltage generation unit 12 is coupled to each source drive unit 10. Each source drive unit 10 further includes a sample memory 101, a hold memory 102, a level shifter 103, and a non-linear digital-to-analog converter (DAC) 104. The sample memory 101 is coupled to the hold memory 102 in each source drive unit 10. The hold memory 102 is coupled to the level shifter 103. The level shifter 103 is coupled to the non-linear DAC 104. The operating principle is that the shift register 11 captures a start pulse STP through a clock signal CLK, and sequentially performs shift action on the start pulse STP, so as to provide a latch timing. The latch timing can trigger the sample memory 101 in each source drive unit 10 to capture an image data IN. When the sample time ends, a line latch signal LS controls the hold memory 102 in each source drive unit 10, such that the data in the sample memory 101 is stored in the hold memory 102, and the data of the hold memory 102 is output to the level shifter 103.

The image data IN is a digital signal operating in a low voltage, however, each source drive unit 10 requires a high voltage signal to drive the display panel 14. Thus, the level shifter 103 performs level shift on the data output by the hold memory 102, such that the level of the data reaches the level for pushing the analog circuit. Later, the image data enters the non-linear DAC 104. The non-linear DAC 104 converts the entered data into a corresponding analog drive signal according to a Gamma reference voltage provided by the Gamma reference voltage generation unit 12, and sends the analog drive signal into an output buffer 13. The output buffer 13 then sends out the interior analog drive signal and drives the display panel 14. In the conventional art, the Gamma reference voltage generation unit 12 trims the level of each Gamma reference voltage, thereby fulfilling the Gamma correction performance.

FIG. 2 is a circuit diagram of the Gamma reference voltage generation unit 12 and the non-linear DAC 104. Referring to FIG. 2, the Gamma reference voltage generation unit 12 is constituted by a plurality of variable resistors R1, R2, R3 . . . RM, a plurality of reference resistors Rf, and a plurality of operational amplifiers OP. The non-linear DAC 104 includes a decoder 1041, a selector 1042, a plurality of reference resistors Rf, a plurality of operational amplifiers OP, and a plurality of fixed resistors RA1, RA2, RA3 . . . RAM. The Gamma reference voltage generation unit 12 is externally connected to a reference voltage Vf, and adjusts the resistances of the plurality of variable resistors R1-RM to generate a plurality of Gamma reference voltage levels. Each operational amplifier OP in the Gamma reference voltage generation unit 12 appropriately amplifies a received voltage signal, and sends the generated voltage signal to the non-linear DAC 104 in each source drive unit 10.

The non-linear DAC 104 receives the reference voltage from the Gamma reference voltage generation unit 12, and is externally connected to a supply voltage VCC. The plurality of fixed resistors RA1-RAM and the plurality of operational amplifiers OP in the non-linear DAC 104 form a plurality of conversion stages. Through the conversion stages, the reference voltage from the Gamma reference voltage generation unit 12 generate and supply a plurality of voltage levels to the selector 1042 to be output selectively. In the non-linear DAC 104, the input data D is decoded by the decoder 1041, and the decoded data is sent to the selector 1042. The selector 1042 is constituted by a plurality of switchers. The switchers in the selector are controlled by the data D sent from the decoder, and the selector selectively outputs a voltage level to serve as an analog drive signal corresponding to the input data.

However, this conversion scheme demands larger quantity of resistors, switchers, and operational amplifiers, such that the layout area of the source driver becomes very large. Referring to FIG. 1, if the display panel 14 has 1024 data lines and the image data IN is 8-bit data, the source driver needs 1024 non-linear DACs 104, and each non-linear DAC 104 needs 2̂8 resistors, switchers, and operational amplifiers OP. That is, the source driver at least requires (2̂8)*1024=262144 resistors, switchers, and operational amplifiers OP. Thus, the layout area of the conventional source driver is very large. Furthermore, in the conventional art, the resistance ratio of each variable resistor R1, R2, R3 . . . RM must be trimmed precisely, thus making it difficult to reduce the fabrication cost.

In view of the above, the non-linear DACs in the conventional source driver require larger quantity of resistors, operational amplifiers, and switchers, while generally the layout area of a chip must be reduced to reduce the fabrication cost. Thus, a larger quantity of resistors, operational amplifiers, and converters will enlarge the layout area of the chip, and thus increase the manufacturing cost, which does not meet the present trend of being light, thin, short, and small. Furthermore, the precision of the DAC depends on the matching degree of the resistors (i.e., the resistance ratio of the bleeder resistors), and if plenty of resistors need precise matching, the time of the layout process will be largely consumed.

Accordingly, the manufacturers of source driver all urgently seek a solution to overcome the above problems.

### SUMMARY OF THE INVENTION

The present invention is directed to a source driver and a Gamma correction method thereof, so as to reduce the circuit layout area, reduce the fabrication cost, and improve the Gamma correction performance.

The present invention provides a source driver, which includes a Gamma correction unit, a latch unit, and a digital-to-analog converter (DAC). The Gamma correction unit is used for receiving an original image data and converting the original image data into a corresponding corrected image data, thereby achieving the Gamma correction performance. The latch unit is coupled to the Gamma correction unit, and is employed for latching the Gamma corrected image data. The DAC is coupled to the latch unit, and is employed for converting the corrected image data latched by the latch unit to a corresponding analog drive signal, so as to drive a display panel.

According to an embodiment of the present invention, the Gamma correction unit further includes a look-up table, and the Gamma correction unit obtains the corresponding corrected image data from the look-up table according to the original image data.

According to an embodiment of the present invention, the DAC further includes an amplifier, a first resistor, and a plurality of conversion stages. A first input end of the amplifier receives a reference voltage, and an output end thereof outputs the analog drive signal. Two ends of the first resistor are respectively connected to a second input end and the output end of the amplifier. A first end of each conversion stage is connected to a second end of the next conversion stage, and a first end of the last conversion stage is connected to the second input end of the amplifier.

In the source driver and the Gamma correction method thereof according to an embodiment of the present invention, the bit of the corrected image data is larger than the bit of the original image data, so as to obtain a preferred resolution to enhance the Gamma correction performance.

In view of the above, the present invention provides a Gamma correction method to obtain a corrected image data. As the source driver of the present invention employs a Gamma correction unit to carry out the Gamma correction performance, the source driver can adopt a linear DAC. Accordingly, the present invention can reduce the chip area of the source driver, and shorten the resistance matching time of the layout process during the fabrication, thus reducing the fabrication cost of the source driver. According to an embodiment of the present invention, the bit of the corresponding corrected image data is larger than the bit of the original image data, so as to increase the resolution, and thus obtain a preferred Gamma correction performance.

In order to make the aforementioned and other objectives, features, and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit diagram of a conventional source driver.

FIG. 2 is a circuit diagram of a Gamma reference voltage generation unit and a non-linear DAC in the conventional source driver.

FIG. 3 is a circuit diagram of the system of a source driver according to an embodiment of the present invention.

FIG. 4 is a circuit diagram of a Gamma correction unit according to an embodiment of the present invention.

FIG. 5 is a Gamma curve diagram according to an embodiment of the present invention.

FIG. 6 is a circuit diagram of an ROM according to an embodiment of the present invention.

FIG. 7A is a schematic view of the resolution of an M-bit corrected image data.

FIG. 7B is a schematic view of the resolution of an (M+2)-bit corrected image data.

FIG. 8 is a circuit diagram of a DAC according to an embodiment of the present invention.

FIG. 9 is a flow chart of a Gamma correction method according to an embodiment of the present invention.

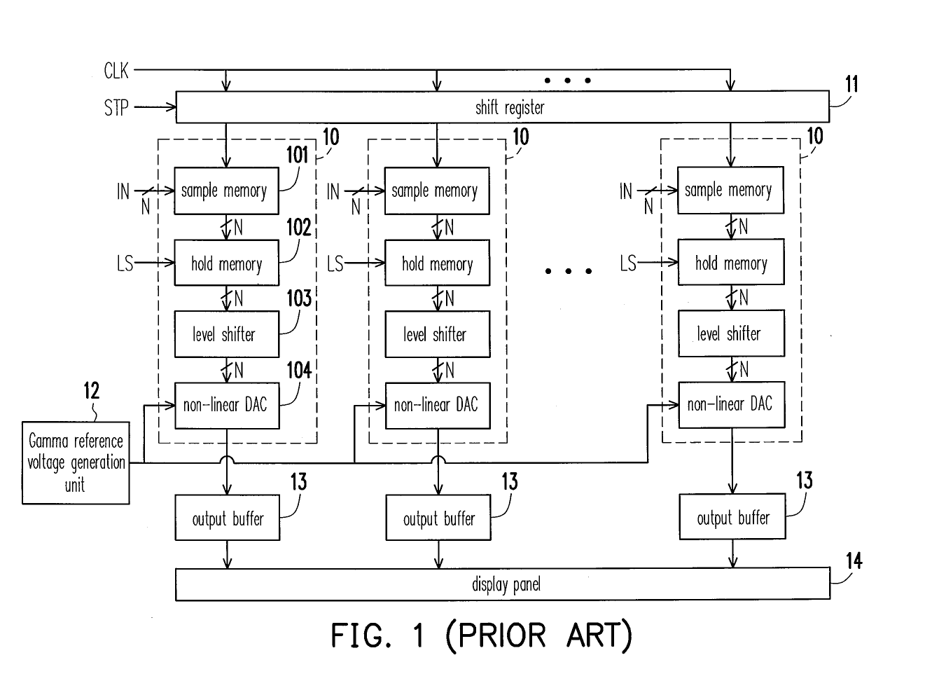

### DESCRIPTION OF EMBODIMENTS

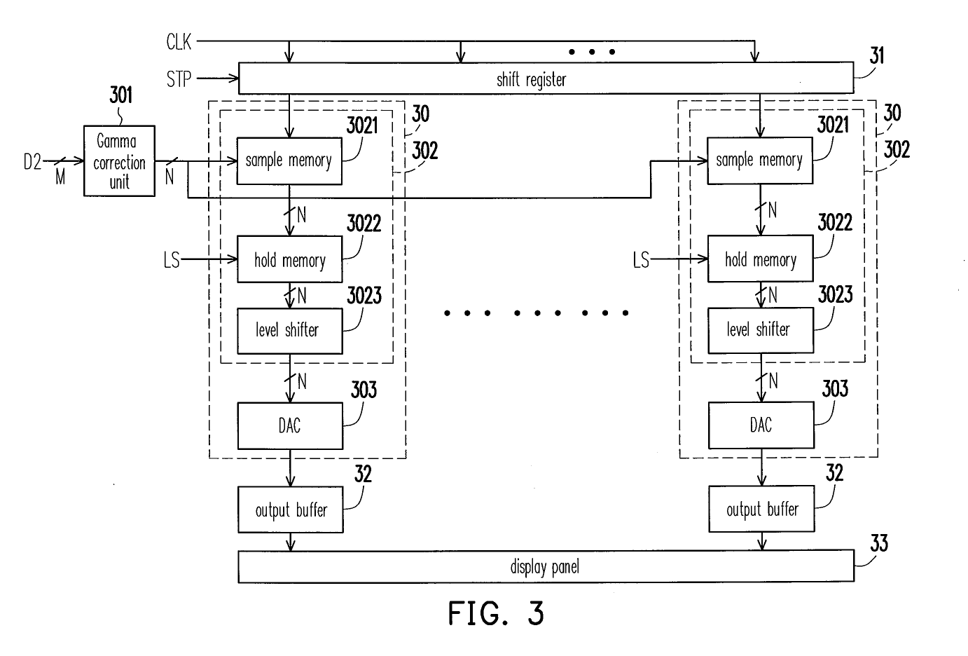

Referring to FIG. 3, a circuit block diagram of a source driver according to an embodiment of the present invention. The source driver includes a plurality of source drive units 30 and a shift register 31. A trigger end of the shift register 31 receives a clock signal CLK, and an input end of the shift register 31 receives a start pulse STP. Each source drive unit 30 is coupled to an output end of a corresponding shift register 31. Each source drive unit 30 includes a Gamma correction unit 301, a latch unit 302, and a digital-to-analog converter (DAC) 303. The input end of the Gamma correction unit 301 is used for receiving an original image data IN. The latch unit includes a sample memory 3021, a hold memory 3022, and a level shifter 3023. An input end of the sample memory 3021 is coupled to an output end of the Gamma correction unit 301, and an output end of the sample memory 3021 is coupled to an input end of the hold memory 3022. A trigger end of the hold memory 3022 is controlled by a line latch signal LS. An output end of the hold memory 3022 is coupled to an input end of the level shifter 3023, and an output end of the level shifter 3023 is coupled to an input end of the linear DAC 303.

The Gamma correction unit 301 is used for receiving an original image data D1 and converting the original image data D1 into a corresponding corrected image data D2. The shift register 31 captures the start pulse STP through the clock signal CLK, and sequentially performs shift action on the start pulse STP, so as to generate a latch timing to control the sample memory 3021 in each source drive unit 30. When the sample memory 3021 of the source drive unit 30 is triggered by the latch timing, the sample memory 3021 captures the corrected image data D2. When the hold memory 3022 is triggered by the line latch signal LS, the hold memory 3022 captures the data stored in the sample memory 3021. After that, the hold memory 3022 outputs the storage result to the level shifter 3023. The level shifter 3023 performs level shift on the input data after correction, such that the level of the data reaches the level of driving the analog circuit, and the data after level shift is sent to the DAC 303. However, if the level of the data has reached the level of driving the analog circuit, the level shifter 3023 can be removed, and the DAC 303 is directly coupled to the hold memory 3022. The DAC 303 receives the data of the latch unit and converts the received data into a corresponding analog drive signal.

An output end of the linear DAC 303 is further coupled to an input end of an output buffer 32, and an output end of the output buffer 32 is coupled to a display panel 33. The output buffer 32 receives the analog drive signal converted by the DAC 303, and sends the analog drive signal to the display panel 33, so as to drive the display panel 33. The display panel 33 can be an LCD panel, organic EL display panel, and the like.

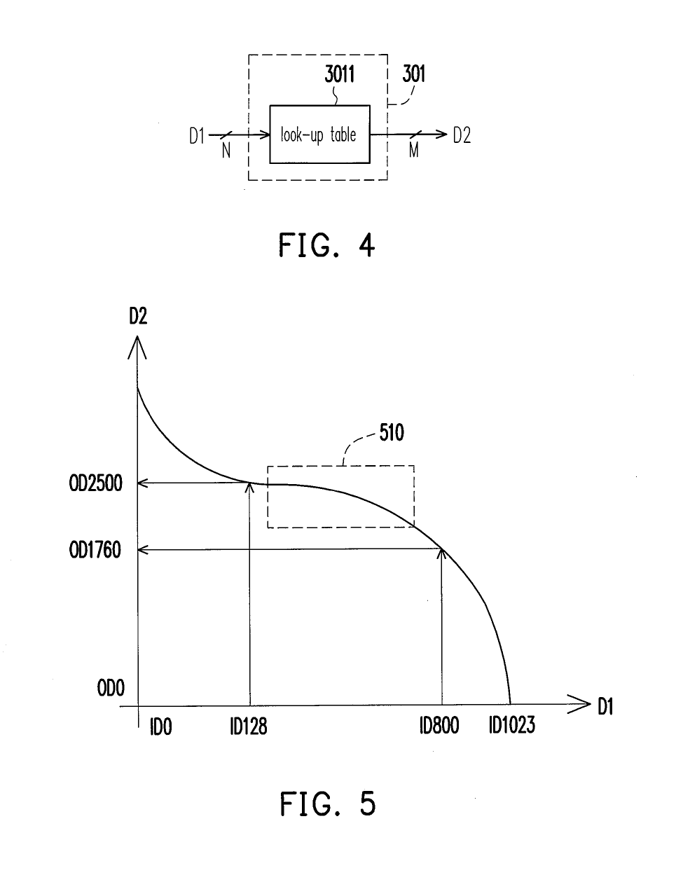

Still referring to FIG. 3 and FIG. 4, as shown in FIG. 4, the Gamma correction unit 301 includes a look-up table 3011. The look-up table 3011 converts the original image data into a corresponding corrected image data. The conversion manner is explained in FIG. 5, in which when the image data D1 is ID128, the corrected image data D2 is OD2500, and when the image data D1 is ID800, the corrected image data D2 is OD1760. The rest of the image data D1 and the corresponding corrected image data D2 can be deduced by analogy in the same manner.

However, though the Gamma correction unit 301 is implemented employing the look-up table 3011, the implementation of the Gamma correction unit 301 is not limited there to as such. The Gamma correction unit 301 can also be designed as an operational logic circuit for performing operation on the input data D1 and output the corresponding corrected image data D2.

The look-up table 3011 is recorded in a memory, for example, a non-volatile memory. By updating the content of the look-up table 3011 in the memory, the user can easily alter the Gamma curve (for example, as shown in FIG. 5). As the Gamma correction mechanism is carried out in a digital manner, the Gamma correction of this embodiment can satisfy the requirement on precision, and the cost can be effectively reduced.

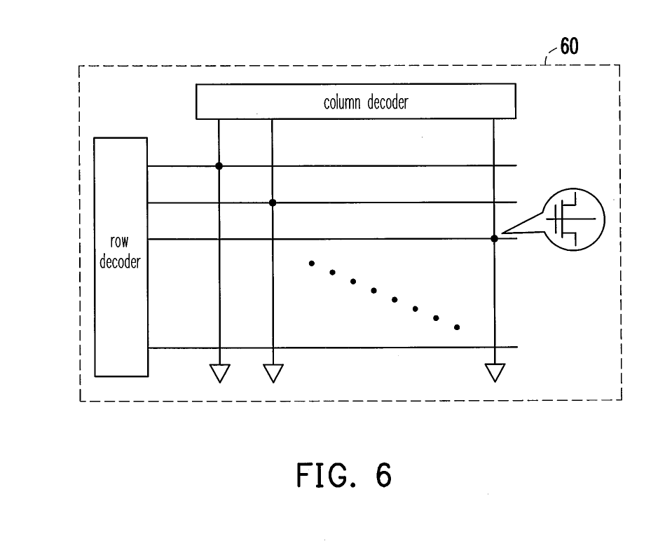

FIG. 6 shows an implementation of the look-up table 3011 as the architecture of an ROM 60 according to an embodiment of the present invention. However, the implementation of the look-up table 3011 in the source driver according to an embodiment of the present invention is not limited thereto, and can be fulfilled through other non-volatile memory architectures, such as EPROM, EEPROM, and flash memory. The user can easily alter the content of the look-up table 3011 according to different Gamma conversion curves, so as to meet various requirements on image quality.

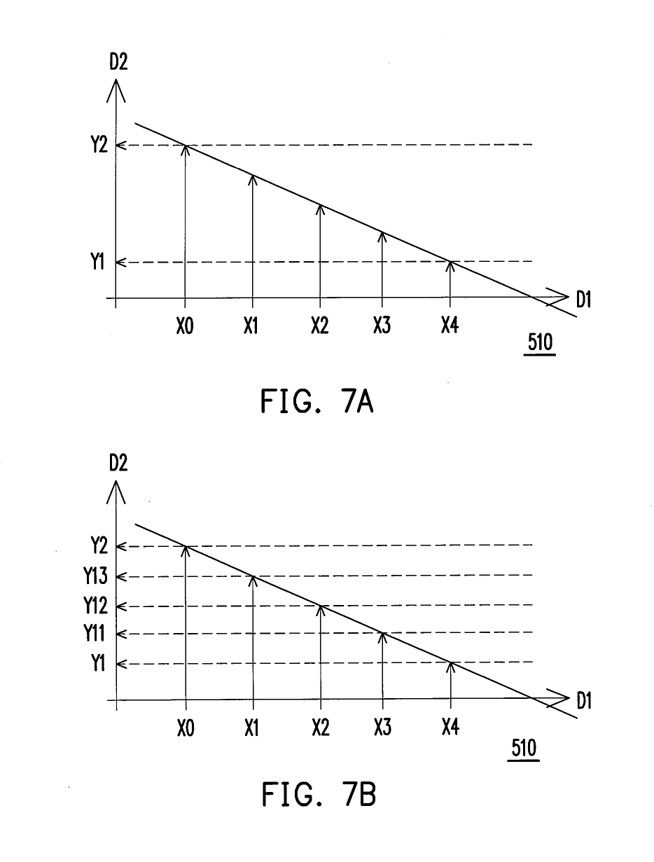

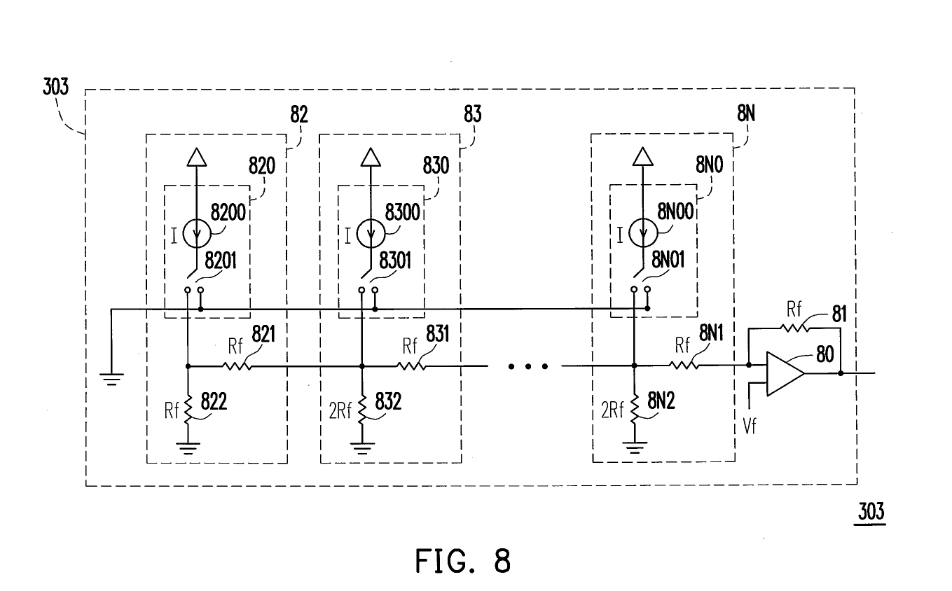

Next, referring to FIG. 3 and FIG. 7, in order to make the source driver according to an embodiment of the present invention have a more preferred resolution than that of the conventional source driver and thus achieving a better Gamma correction performance, in the source driver according to an embodiment of the present invention, the bit of the corrected image data is larger than the bit of the original image data. FIGS. 7A and 7B are schematic views of the resolutions of M-bit corrected image data and (M+2)-bit corrected image data, and the curve is an enlarged view of the section 510 in the Gamma conversion curve of FIG. 5. As shown in FIG. 7A, if the M-bit is used to represent the corrected image data, when the input M-bit original image data D1 are X0, X1, X2, X3, X4 in sequence, the corrected image data D2 are Y2, Y1, Y1, Y1, Y1 in sequence. That is, data X1, X2, X3, X4 representing different gray scales may be converted into data Y1 of the same gray scale. If (M+2)-bit is used to represent the corrected image data, a preferred resolution is obtained. For example, as shown in FIG. 7B, when the input M-bit original image data D1 are X0, X1, X2, X3, X4 in sequence, the corrected image data D2 are Y2, Y13, Y12, Y11, Y1 in sequence. In other words, the corrected image data of the image data X1, X2, X3, X4 are no longer Y1, but data Y13, Y12, Y11, Y1 representing different gray scales.

Thus, the resolution can be enhanced by making the bit of the corrected image data larger than the bit of the original image data, thus obtaining a preferred Gamma correction performance. According to a simulation result of a preferred embodiment of the present invention, when the bit of the corrected image data is two bits larger than the bit of the original image data, a better Gamma correction performance is achieved, and the larger the bit of the corrected image data is, the better the resolution will be. The user can determine the bit of the corrected image data D2 in this embodiment on demands.

Further, referring to FIGS. 3 and 8, FIG. 8 shows a circuit diagram of the DAC 303 in FIG. 3. Here, it is assumed that the bit of the corrected image data D2 is N, and thus the bit of the data output by the level shifter 3023 is N. As shown in FIG. 8, the DAC 303 includes an amplifier 80, a first resistor 81, and a plurality of conversion stages 82, 83, 84 . . . 8N. A first input end of the amplifier 80 is connected to a reference voltage Vf, and an output end thereof is used to output the analog drive signal. Two ends of the first resistor 81 are respectively connected to a second input end and the output end of the amplifier. For the plurality of conversion stages 82-8N, a first end of each of the conversion stages 82-8N−1 is connected to a second end of the next conversion stage 83-8N, and a first end of the last conversion stage 8N is connected to the second input end of the amplifier 80.

The conversion stages 82-8N each include a controlled current source unit 820, 830 . . . 8N0, a second resistor 821, 831 . . . 8N1, and a third resistor 822, 832 . . . 8N2. The controlled current source units 820-8N0 each further include a current source 8200, 8300 . . . 8N00 and a switch 8201, 8301 . . . 8N01. The first end and second end of each of the second resistors 821-8N1 respectively serve as the first end and second end of each of the conversion stages 82-8N. The second end of each of the second resistors 821-8N1 is connected to each of the controlled current source units 820-8N0. The first end of each of the third resistors 822-8N2 is connected to the second end of each of the second resistors, and the second end of each of the third resistors 822-8N2 is grounded. The switches 8201-8N01 are respectively coupled between the current sources 8200-8N00 and the second resistors 821-8N1.

To achieve linear conversion, in the first conversion stage 82 among the conversion stages 82-8N, the resistance of the second resistor 821 is similar to that of the third resistor 822, and in other conversion stages 83-8N, the resistance of each of the third resistors 832-8N2 almost doubles the resistance of each of the second resistors 831-8N1. When the corrected image data enters the DAC 303, the switches 8201-8N01 are respectively controlled by each bit of the output data of the level shifter 3023, so as to control whether to allow a fixed current respectively provided by the current sources 8200-8N00 pass through the corresponding switches 8201-8N01. Accordingly, the controlled current source units 820-8N0 determine whether to output a current according to the output data of the level shifter 3023. The second resistors 821-8N1 and the third resistors 822-8N2 convert the current output by the controlled current source units 820-8N0 into a voltage signal. The amplifier 80 amplifies the voltage signal, and generates an analog drive signal which is proportional to the corrected image data D2. In addition, through a circuit with the DAC connected in parallel and proper control on the circuit, the driver provided by this embodiment can handle the polarity inversion problem of a display panel, thereby achieving the polarity inversion performance of the conventional source driver. Thus, the source driver of the present invention is superior to the conventional one in many aspects.

The DAC 303 comprises a common R-2R ladder structure. By adopting such a DAC, the source driver according to an embodiment of the present invention needs fewer resistors, switchers, and operational amplifiers than a conventional source driver. It is assumed that a source driver has 1024 linear DACs of R-2R architecture, and N=8, and thus only 1024*(8*2+1)=17408 resistors, 1024*(8)=8192 switches and current sources, and 1024 operational amplifiers are required. In the embodiment of the present invention, though the DAC 303 is implemented in the above manner, other schemes can also be employed for the same purpose in practice, for example, adopting a DAC of a multiple resistor string structure.

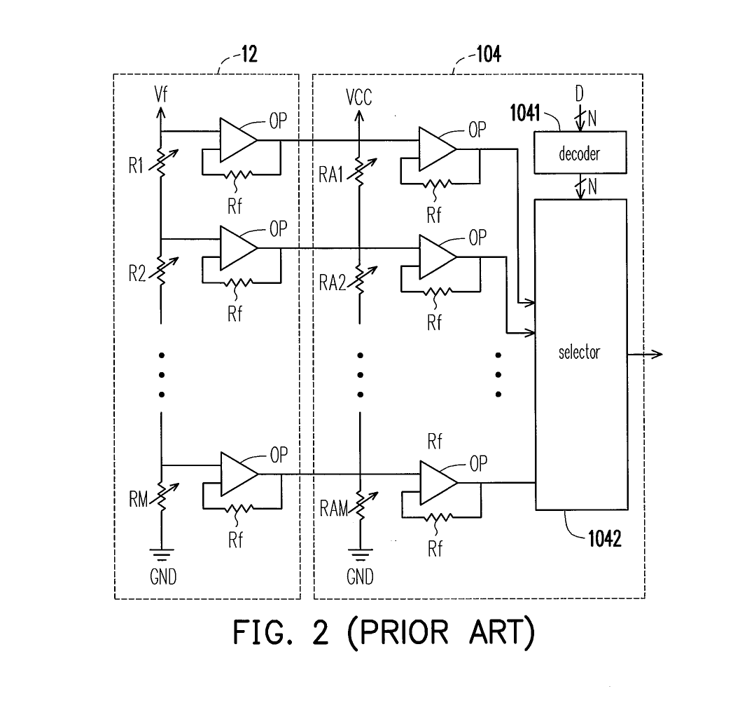

Table 1 is used to illustrate the comparison of the number of the resistors and switches required by the non-linear DAC 104 in FIG. 2 and the linear DAC 303 in FIG. 8. It can be clearly seen from Table 1 that, as this embodiment can adopt a linear DAC, the circuit area of the source drive unit 30 can be significantly reduced. Under the recent development trend of high gray scale (the bit of the image data is becoming greater and greater) and large area (the number of the required source drive unit 30 is becoming larger and larger) of the panel display device, this embodiment can better satisfy the requirement on developing the panel display device.

TABLE 1
Comparison table between the non-linear DAC 104 in FIG. 2
and the linear DAC 303 in FIG. 8 (the bit of the image
data is assumed to be N)

| | Number of Resistors | Number of Switches |
|---|---|---|
| Non-linear DAC 104 | 2^{N} | 2^{N+1} − 1 |
| Linear DAC 303 | 3N + 1 | N |

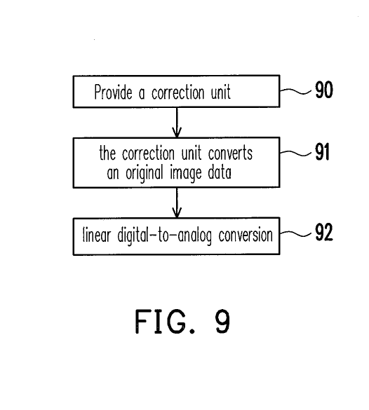

Referring to FIG. 9, a flow chart of a Gamma correction method of the above embodiments is shown. The method includes providing a correction unit in Step 90; converting an original image data into a corresponding corrected image data by the correction unit, so as to achieve the Gamma correction performance in Step 91; and performing a linear digital-to-analog conversion on the corrected image data by the DAC in Step 92. The DAC linearly converts the corresponding corrected image data into a corresponding analog drive signal, so as to drive a display panel, which can be an LCD panel.

In view of the above, according to the source driver and the Gamma correction method thereof provided by the present invention, a Gamma correction method is provided to obtain a corrected image data. In the above embodiments, the source driver adopts a Gamma correction unit, such that the DAC can adopt the structure of a linear DAC to linearly convert the corrected image data, so as to obtain an analog drive signal. Thus, the present invention can reduce the chip area of the source driver, and shorten the resistance matching time of the layout process during the fabrication, thereby lowering the fabrication cost of the source driver. Moreover, according to the source driver and the Gamma correction method thereof provided by the present invention, the bit of the corresponding corrected image data is larger than the bit of the original image data, and the resolution is thus increased, thereby obtaining a preferred Gamma correction performance.

Though the present invention has been disclosed above by the preferred embodiments, they are not intended to limit the present invention. Anybody skilled in the art can make some modifications and variations without departing from the spirit and scope of the present invention. Therefore, the protecting range of the present invention falls in the appended claims.

What is claimed is:

1. A source driver, comprising:
a Gamma correction unit, for receiving an original image data and converting the original image data into a corresponding corrected image data;
a latch unit, coupled to the Gamma correction unit, for latching the corrected image data; and
a digital-to-analog converter (DAC), coupled to the latch unit, for converting the corrected image data latched by the latch unit to a corresponding analog drive signal.

2. The source driver as claimed in claim 1, wherein the Gamma correction unit comprises:
a look-up table, wherein the Gamma correction unit obtains the corresponding corrected image data from the look-up table according to the original image data.

3. The source driver as claimed in claim 2, wherein the look-up table is recorded in a memory.

4. The source driver as claimed in claim 3, wherein the memory is a non-volatile memory.

5. The source driver as claimed in claim 1, wherein the bit number of the corrected image data is larger than the bit number of the original image data.

6. The source driver as claimed in claim 1, wherein a level of the analog drive signal is proportional to the corrected image data.

7. The source driver as claimed in claim 1, wherein the DAC comprises a linear DAC.

8. The source driver as claimed in claim 7, wherein the linear DAC comprises:
an amplifier, comprising a first input end receiving a reference voltage and an
output end outputting the analog drive signal;
a first resistor, comprising two ends respectively connected to a second input end and the output end of the amplifier; and
a plurality of conversion stages, each comprising a first end connected to a second end of the next conversion stage, and a first end of the last conversion stage connected to the second input end of the amplifier, wherein each conversion stage comprises:
a controlled current source unit, for determining whether or not to output a current according to the control of a bit of the corrected image data;
a second resistor, comprising a first end and a second end respectively serving as the first end and the second end of the conversion stage, wherein the second end of the second resistor is connected to the controlled current source unit; and
a third resistor, comprising a first end connected to the second end of the second resistor, and a second end of the third resistor grounded.

9. The source driver as claimed in claim 8, wherein in a first conversion stage of the conversion stages, a resistance of the second resistor is equal to that of the third resistor; in the rest of the conversion stages, a resistance of the third resistor is twice that of the second resistor.

10. The source driver as claimed in claim 8, wherein the controlled current source unit comprises:
a current source, for providing a fixed current; and
a switch, coupled between the current source and the second resistor, for determining whether or not to allow the fixed current pass through the switch according to the control of a bit of the corrected image data.

11. The source driver as claimed in claim 1, wherein the latch unit comprises:
a sample memory, for latching the corrected image data according to a latch timing, and outputting the latch result;
a hold memory, coupled to the sample memory, for storing an output of the sample memory according to a line latch signal, and outputting a storage result; and
a level shifter, coupled between the hold memory and the DAC.

12. The source driver as claimed in claim 11, further comprising:
a shift register, coupled to the latch unit, for providing the latch timing.

13. The source driver as claimed in claim 1, farther comprising:
an output buffer, coupled between the DAC and a display panel.

14. The source driver as claimed in claim 13, wherein the display panel is an LCD panel.

15. A Gamma correction method of a source driver, comprising:
providing a correction unit;
converting an original image data to a corresponding corrected image data through the correction unit; and
converting the corrected image data to a corresponding analog drive signal.

16. The Gamma correction method of a source driver as claimed in claim 15, wherein the correction unit is a look-up table.

17. The Gamma correction method of a source driver as claimed in claim 16, wherein the look-up table is recorded in a memory.

18. The Gamma correction method of a source driver as claimed in claim 17, wherein the memory is a non-volatile memory.

19. The Gamma correction method of a source driver as claimed in claim 15, wherein the bit of the corrected image data is larger than the bit of the original image data.

20. The Gamma correction method of a source driver as claimed in claim 15, wherein the analog drive signal is used to drive a display panel.

21. The Gamma correction method of a source driver as claimed in claim 20, wherein the display panel is an LCD panel.
